(19) United States
(12) Patent Application Publication
(10) Pub. No.: US 2018/0183581 A1
(43) Pub. Date: Jun. 28, 2018

(54) ARRANGEMENTS FOR DATALINK SECURITY

(71) Applicant: INTEL CORPORATION, SANTA CLARA, CA (US)

(72) Inventors: REOUVEN ELBAZ, Hillsboro, OR (US); DANIEL NEMIROFF, El Dorado Hills, CA (US); WILLIAM STEVENS, JR., Folsom, CA (US)

(73) Assignee: INTEL CORPORATION, SANTA CLARA, CA (US)

(21) Appl. No.: 15/393,179

(22) Filed: Dec. 28, 2016

(51) Int. Cl. H04L 9/08; H04L 29/06; H04W 12/06

(52) U.S. Cl. CPC H04L 9/0819; H04L 9/0825; H04W 12/06; H04L 63/08; H04L 63/0442

(57) ABSTRACT

Various embodiments for providing datalink security in a datalink between a first hardware device (e.g., a system-on-a-chip (SoC) device) and a second hardware device (e.g., an encrypted storage device) are described. Various embodiments using differing types of keys and setups are described and claimed.

### TECHNICAL FIELD

Examples described herein are generally related to arrangements (e.g., apparatus, system, method, programming) providing datalink security between devices.

### BACKGROUND

Datalink security remains of utmost importance within electronic technologies. As one non-limiting example environment, there exists a strong trend toward widespread use of remotely-accessible multi-user systems (e.g., cloud computing and/or storage services). With such, computing is performed or data is stored on remote electronic (e.g., server) devices which may be provided and maintained by third parties at some remote third party facility.

### BRIEF DESCRIPTION OF THE DRAWINGS

FIG. 1 illustrates an example of a system.

FIG. 2 illustrates an example of another system.

FIG. 3 illustrates an example of a system on a chip (SoC) arrangement.

FIG. 4 illustrates an example of another system having cryptography applied across a datalink.

FIGS. 5-8 illustrate example timelines of example embodiments.

FIG. 9 illustrates an example pairing key (Kₚ) exchange protocol at system manufacturing.

FIG. 10 illustrates an example session key (Kₛ) exchange protocol at a link reset.

FIG. 11 illustrates an example of a storage medium.

### DETAILED DESCRIPTION

Examples discussed herein are generally directed to improvements for providing datalink security to a datalink between multiple devices, such as a first and a second hardware device, for example. In one or more embodiments, for example, the present disclosure can be implemented to provide security to a datalink between a system-on-a-chip (SoC) device and an encrypted storage device.

Computing is performed or data is stored on remote electronic (e.g., server) devices which may be provided and maintained by third parties at some remote third party facility. While some portions (e.g., self-encrypted storage) of the remote electronic devices may be secure from third party access, the remote electronic devices may also contain one or more normally unsecured datalinks (e.g., data buses) therein. Unsecured datalinks may represent a target which a nefarious party (e.g., competitor) might attempt to tap, to access data. What is needed, are arrangements providing datalink security to such otherwise normally unsecured datalinks, and to do so without significant impact on latency experienced by an end user.

To solve these and other problems, embodiments provide enhanced security for the datalink. For instance, one or more types of keys (e.g., two keys) may be utilized in some embodiments for pairing operations. In particular, as one example, a pairing key may be established for both the SoC and the encrypted storage at manufacturing or provisioning of the devices. Subsequently, during operation, the SoC and encrypted storage devices can generate and secretly exchange a session key via a cryptographic exchange based on the pairing key. The SoC and encrypted storage devices can utilize the pairing key and/or session key to send and receive information element (e.g., data) of the datalink in a secure manner.

The use of a pairing key provides several technical advantages over conventional techniques. For instance, enables use of symmetric cryptography when the devices are deployed in the field, and also, helps minimize boot time impact due to an enabled key exchange protocol.

Numerous specific details have been set forth herein to provide a thorough understanding of the example embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative, and do not necessarily limit the scope of the embodiments.

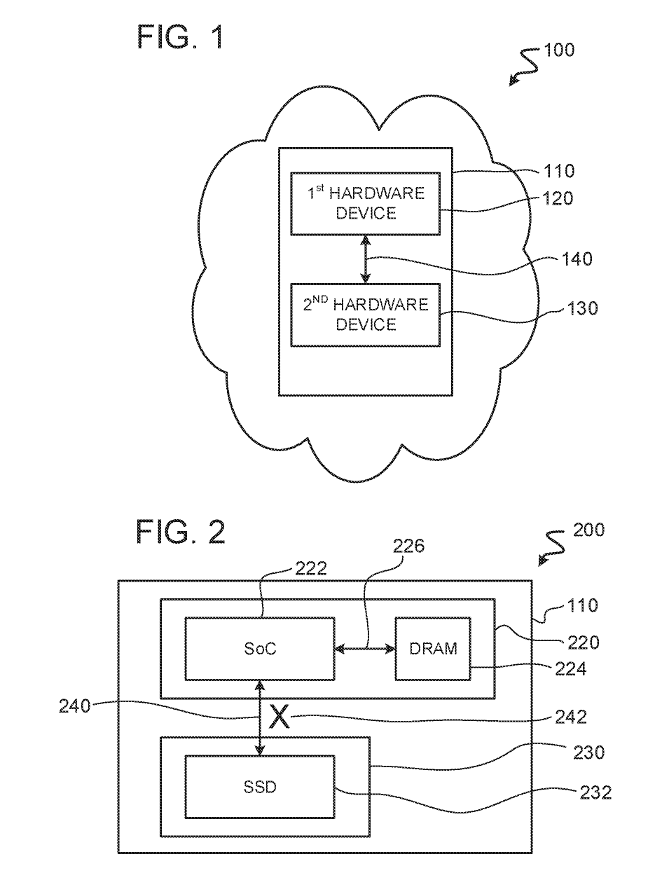

FIG. 1 illustrates an example environment 100 containing an example apparatus (e.g., server) 110 owned and maintained, for example, by an end-user owner. More particularly, the server 110 may have been configured in a predetermined end-use configuration, for example, the server 110 may be configured to serve as a host providing any desired function or services to multiple differing end-users. Within the server 110, shown is a first hardware device 120, a second hardware device 130, and a datalink 140 (e.g., data bus) communicatively coupling the first hardware device 120 and the second hardware device 130, to allow data communication between the first hardware device 120 and the second hardware device 130. Although FIG. 1 may show a limited number and/or types of components by way of example, it can be appreciated that a greater or a fewer number, or differing types, of components may be employed for a given implementation.

A hardware device may be any apparatus or device which is at least partially constructed (or embodied) of hardware, and having communication abilities for communicating with other hardware apparatus via a datalink (e.g., bus). The aforementioned system-on-a-chip (SoC) device and encrypted storage device are each non-limiting, non-exhaustive examples of a hardware device. A network interface controller (NIC) may be another example. Embodiments are not limited in this context.

Data being communicated across the datalink 140 (without the datalink security provided by the present embodiments) may be accessible by a nefarious party (e.g., competitor), e.g., if the nefarious party were to gain access to and tap the datalink 140 to access the data. Of course, the server 110 owner has interest in prevention of a potential for a data breach in order to maintain its reputation for providing secure hosting services. The client has interest in avoiding a data breach in order to maintain the secrecy of its data to maintain its business advantage.

FIG. 2 is used to illustrate example specific (but non-limiting) components 200 which may exist within the example server 110. More particularly, a printed circuit board (PCB) or package combination 220 which includes a System-on-Chip (SoC) device 222, dynamic random access memory (DRAM) 224 and a bus 226, is illustrated as a non-limiting example of the first hardware device 120. Although the FIG. 2 combination 220 may show a limited number or types of components by way of example, it can be appreciated that a greater or a fewer number or differing types of components may be employed for a given implementation.

In general, the SoC device 222 may include various physical and/or logical components for communicating information, which components may be implemented as hardware, software, or any combination thereof, as desired for a given set of design parameters or performance constraints. Although the FIG. 2 SoC device 222 may show a limited number or types of components by way of example, it can be appreciated that a greater or a fewer number or differing types of components may be employed for a given implementation.

In various embodiments, the SoC device 222 may be implemented for a personal computer (PC), consumer electronics (CE), and/or mobile platform as a system within and/or connected to a device such a PC, set-top box (STB), television (TV) device, Internet Protocol TV (IPTV) device, media player, and/or smart phone. Other examples of such devices may include, without limitation, a workstation, terminal, server, media appliance, audio/video (A/V) receiver, digital music player, entertainment system; digital TV (DTV) device, high-definition TV (HDTV) device, direct broadcast satellite TV (DBS) device, video on-demand (VOD) device, Web TV device, digital video recorder (DVR) device, digital versatile disc (DVD) device, high-definition DVD (HD-DVD) device, Blu-ray disc (BD) device, video home system (VHS) device, digital VHS device, a digital camera, a gaming console, display device, notebook PC, a laptop computer, portable computer, handheld computer, personal digital assistant (PDA), voice over IP (VoIP) device, cellular telephone, combination cellular telephone/PDA, pager, messaging device, wireless access point (AP), wireless client device, wireless station (STA), base station (BS), subscriber station (SS), mobile subscriber center (MSC), mobile unit, and so forth.

In applications including wireless capabilities, for example, the SoC device 222 may be implemented within and/or connected to a device including one more interfaces and/or components for wireless communication such as one or more transmitters, receivers, transceivers, chipsets, amplifiers, filters, control logic, network interface cards (NICs), antennas, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the SoC device 222 may form part of a wired communications system, a wireless communications system, or a combination of both. For example, the SoC device 222 may be arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The SoC device 222 also may be arranged to communicate information over one or more types of wireless communication links. Examples of a wireless communication link may include, without limitation, a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. Although certain embodiments may be illustrated using a particular communications media by way of example, it may be appreciated that the principles and techniques discussed herein may be implemented using various communication media and accompanying technology.

In various embodiments, the SoC device 222 may be arranged to operate within a network, such as a Wide Area Network (WAN), Local Area Network (LAN), Metropolitan Area Network (MAN), wireless WAN (WWAN), wireless LAN (WLAN), wireless MAN (WMAN), wireless personal area network (WPAN), Worldwide Interoperability for Microwave Access (WiMAX) network, broadband wireless access (BWA) network, the Internet, the World Wide Web, telephone network, radio network, television network, cable network, satellite network such as a direct broadcast satellite (DBS) network, Code Division Multiple Access (CDMA) network, third generation (3G) network such as Wide-band CDMA (WCDMA), fourth generation (4G) network, Time Division Multiple Access (TDMA) network, Extended-TDMA (E-TDMA) cellular radiotelephone network, Global System for Mobile Communications (GSM) network, GSM with General Packet Radio Service (GPRS) systems (GSM/GPRS) network, Synchronous Division Multiple Access (SDMA) network, Time Division Synchronous CDMA (TD-SCDMA) network, Orthogonal Frequency Division Multiplexing (OFDM) network, Orthogonal Frequency Division Multiple Access (OFDMA) network, North American Digital Cellular (NADC) cellular radiotelephone network, Narrowband Advanced Mobile Phone Service (NAMPS) network, Universal Mobile Telephone System (UMTS) network, and/or any other wired or wireless communications network configured to carry data in accordance with the described embodiments.

The SoC device 222 may be arranged to communicate one or more types of information, such as media information and control information. Media information generally may refer to any data representing content meant for a user, such as image information, video information, audio information, A/V information, graphical information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various implementations, the media information and control information may be segmented into a series of packets. Each packet may include, for example, a discrete data set having a fixed or varying size represented in terms of bits or bytes. It can be appreciated that the described embodiments are applicable to any type of communication content or format, such as packets, frames, fragments, cells, windows, units, and so forth.

The SoC device 222 may communicate information in accordance with one or more protocols. A protocol may include a set of predefined rules or instructions for managing communication among nodes. In various embodiments, for example, the communications system may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

The SoC device 222 may communicate information in accordance with one or more standards as promulgated by a standards organization, such as the International Telecommunications Union (ITU), the International Organization for Standardization (ISO), the International Electrotechnical Commission (IEC), the Institute of Electrical and Electronics Engineers (IEEE), the Internet Engineering Task Force (IETF), and so forth. In various embodiments, for example, the SoC device 222 may communicate information according to media processing standards such as, for example, the ITU/IEC H.263 standard (Video Coding for Low Bitrate Communication, ITU-T Recommendation H.263v3, published November 2000), the ITU/IEC H.264 standard (Video Coding for Very Low Bit Rate Communication, ITU-T Recommendation H.264, published May 2003), Motion Picture Experts Group (MPEG) standards (e.g., MPEG-1, MPEG-2, MPEG-4), Digital Video Broadcasting (DVB) terrestrial (DVB-T) standards, DVB satellite (DVB-S or -S2) standards, DVB cable (DVB-C) standards, DVB terrestrial for handhelds (DVB-H), National Television System Committee (NTSC) and Phase Alteration by Line (PAL) standards, Advanced Television Systems Committee (ATSC) standards, Society of Motion Picture and Television Engineers (SMPTE) standards such as the SMPTE 421M or VC-1 standard based on Windows Media Video (WMV) version 9, Digital Transmission Content Protection over Internet Protocol (DTCP-IP) standards, High performance radio Local Area Network (HiperLAN) standards, and so forth.

In various embodiments, the SoC device 222 may be arranged to receive media content from a media source. The media source generally may include various devices and/or systems capable of delivering static or dynamic media content to the SoC device 222. In one embodiment, for example, the media source may include a multimedia server arranged to provide broadcast or streaming media content. In other embodiments, the media source may include or form part of a media distribution system (DS) or broadcast system such as an over-the-air (OTA) broadcast system, DVB system, radio broadcast system, satellite broadcast system, and so forth. The media source may be implemented within a VOD system or interactive television system that allows users to select, receive, and view video content over a network. The media source also may include or form part of an IPTV system that delivers digital television content over an IP connection, such as a broadband connection. The embodiments are not limited in this context.

In various embodiments, the SoC device 222 may support encryption in accordance with the Advanced Encryption Standard (AES) (National Institute of Standards and Technology (NIST), Advanced Encryption Standard (AES), Federal Information Processing Standards (FIPS) Publication 197, Nov. 26, 2001). The SoC device 222 also may support Advanced Access Content System (AACS) encryption, Data Encryption Standard (DES) encryption, Triple DES (3DES) for key ladder generation, Diffie-Helman encryption, Rivest, Shamir, and Adleman (RSA) encryption, Elliptic curve cryptography (ECC) encryption, hard disk drive (HDD) encryption, DTCP-IP encryption, Cryptomeria Cipher (C2) encryption, Content Scramble System (CSS) encryption, and so forth.

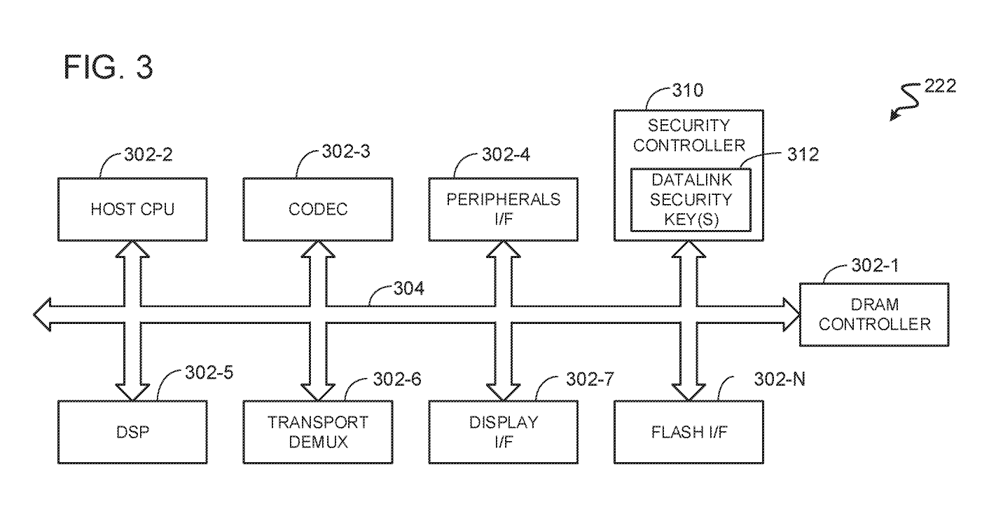

FIG. 3 illustrates an example of a system on a chip (SoC) arrangement. As illustrated, the SoC device 222 may include a plurality of functional units 302-1 to a, where “a” may represent any positive integer value limited only by the physical capacity of the SoC device 222. The plurality of functional units 302-a may be implemented within the SoC device 222, for example, on a single chip or integrated circuit (IC). The IC or PCB may include, for example, conductive traces, via structures, and/or one or more laminates fabricated by processes such as etching, bonding, drilling, and plating. In some embodiments, the PCB may include a flexible material, such as a flexible printed circuit (FPC). Although FIG. 3 may show a limited number and/or types of components by way of example, it can be appreciated that a greater or a fewer number, or differing types, of components may be employed for a given implementation.

In various embodiments, each of the plurality of functional units 302-a may include hardware and/or software for performing one or more operations for the SoC device 222. The functional units 302-a maybe implemented, for example, by various logic devices such as a central processing unit (CPU), microcontroller, microprocessor, general purpose processor, dedicated processor, chip multiprocessor (CMP), media processor, digital signal processor (DSP), network processor, co-processor, input/output (I/O) processor, application specific integrated circuit (ASIC), field programmable gate array (FPGA), programmable logic device (PLD), and so forth. In various implementations, one or more of the functional units 302-a may include one or more processing cores arranged to execute digital logic and/or provide for multiple threads of execution.

The functional units 302-a also may include memory implemented by one or more types of computer-readable storage media such as volatile or non-volatile memory, removable or non-removable memory, erasable or non-erasable memory, writeable or re-writeable memory, and so forth. In various embodiments, one or more of the functional units 302-a may include addressable memory locations in main memory, memory space, and/or registers implemented as random-access memory (RAM) and/or read-only memory (ROM), for example.

As shown in the embodiment of FIG. 3, the plurality of functional units 302-a may include a DRAM controller 302-1, a host CPU 302-2, an encoder/decoder (codec) 302-3, a peripherals interface (I/F) 302-4, a DSP 302-5, a transport demultiplexer (demux) 302-6, a display I/F 302-7, and a flash I/F 302-N. The embodiments are not limited in this context.

In this embodiment, the DRAM controller 302-1 may be arranged to control the storage and retrieval of data from an off-chip DRAM 224 (see FIG. 2) such as Synchronous Dynamic RAM (SDRAM), Double-Data-Rate RAM (DDR RAM), DDR SDRAM, and so forth, via a data path 226 (see FIG. 2).

In various implementations, data may be stored to and/or retrieved from the off-chip DRAM in connection with networking, multimedia, and/or communications applications performed by the SoC device 222. In some cases, the DRAM controller 302-1 may implement tamper-resistant code and other mechanisms to protect data when transferred to and from the off-chip DRAM. In the present discussions, it will be assumed that mechanisms have been implemented within the FIG. 2 example arrangement to protect data when transferred to and from the off chip DRAM 224 via the bus 226, to the SoC device 222.

In such situation, the PCB or package 220 (including the SoC device 222, dynamic random access memory (DRAM) 224 and bus 226) may be considered as being included within a “trust boundary”. “Trust boundary” for the purposes of this disclosure, means that sufficient protective countermeasure arrangements have been made with respect to the items within the trust boundary, such that a sufficient probability exists that it is unlikely that a nefarious party could tap any portion of the arrangement and successfully access intelligible data. Thus, within FIG. 2, the FIG. 2 drawn rectangle labeled with 220 may be taken as a representation of not only the PCB or package 220, but also may be taken as a representation of the trust boundary of the PCB or package 220.

Regarding operations of the FIG. 3 example functional units, the host CPU 302-2 may be arranged to perform various operations such as initialization (e.g., boot) and issuing commands to manage or control networking, multimedia, and/or communications applications for the SoC device 222. The host CPU 302-2 may be arranged, for example, to manage the manipulation of data (e.g., read, write, and erase) within the SoC device 222 to control such applications. In various embodiments, the host CPU 302-2 may include a microcontroller or other computing device arranged to execute logic implemented as software (e.g., operating system (OS) software, application software), code (e.g., boot code), and/or firmware.

The codec 302-3 may be arranged to perform various encoding, decoding, and/or transcoding operations on data within the SoC device 222. The codec 302-3 may include, for example, one or more audio and/or or video codecs (e.g., H.264, MPEG-2, MPEG-4, VC-1 codecs) for performing operations such as decompressing compressed media content prior to playback. In various implementations, the codecs may include encrypted code in DRAM and/or use a fixed mask ROM to prevent unauthorized code execution. For example, host-based soft codecs may address and ensure isolated execution.

The peripherals I/F 302-4 may be arranged to receive data delivered to the SoC device 222 from an off-chip media source (not shown). In various implementations, the peripherals I/F 302-4 may be arranged to receive media content delivered over an IP-based Ethernet or PCI connection.

The DSP 302-5 may be arranged to perform various signal processing operations on data within the SoC device 222. In various implementations, the DSP 302-5 may be arranged to perform audio signal processing, digital image processing and/or speech processing operations for networking, multimedia, and/or communications applications of the SoC device 222.

The transport demux 302-6 may be arranged to receive non-scrambled, scrambled and/or encrypted media content delivered to the SoC device 222, and if scrambled and/or encrypted, to descramble and/or decrypt the media content to recover the original content. In various implementations, the transport demux 302-6 may receive media content as a non-scrambled, scrambled and/or encrypted transport stream through one or more tuners and/or interfaces. The transport demux 302-6 may be arranged to demultiplex a stream. For example, the incoming stream to the SoC device 222 may include many audio and video streams time-multiplexed into a single multi-program transport stream, and the transport demux 302-6 may be arranged to separate the multi-program transport stream into one or more stand-alone streams (e.g., video stream, audio stream, data stream, etc.).

The display I/F 302-7 may be arranged to perform various processing operations on data within the SoC device 222 for rendering, displaying, and/or playing media content on a screen or other user interface (UI). In various implementations, the display I/F 302-7 may include a graphics engine arranged to support 2D/3D graphics performance, multiple video textures, texture blending, and/or texture compression.

The flash I/F 302-N may be arranged to control the storage and retrieval of data from an off-chip flash memory such as NOR or NAND flash memory. In various implementations, data may be stored to and/or retrieved from the off-chip flash memory in connection with networking, multimedia, and/or communications applications performed by the SoC device 222.

As illustrated in the embodiment of FIG. 3, the SoC 222 functional units 302-a may be connected and/or logically coupled by a bus 304. In various embodiments, the bus 304 may be arranged to interconnect each of the functional units 302-a within the SoC device 222. The bus 304 may include conductive traces or lines for carrying signals such as address signals, data signals, and/or control signals. In various implementations, each of the functional units 302-a may be arranged to operate as a master of the shared on-chip bus 304 having the ability to read and write data to any other functional unit of the SoC device 222.

The bus 304 may be implemented, for example, as a Peripheral Component Interconnect (PCI) bus, PCI Extended (PCI-X) bus, PCI Express (PCIe) bus, XSI bus, CardBus, and so forth. Although the bus 304 may be illustrated and described as including a certain type and/or number of buses or conduction paths for ease of understanding, it may be appreciated that various bus architectures may be used for a given implementation. It also can be appreciated that, in some implementations, the functional units 302-a may be arranged to communicate with each other by data and descriptor passing over direct connections. In any event, within the present discussions, it will be assumed that the bus 304 is considered as being included within the trust boundary, meaning that sufficient protective countermeasure arrangements have been made with respect to the bus such that a sufficient probability exists that it is unlikely that a nefarious party could tap any portion of the bus and successfully access intelligible data.

Discussion turns next to the second hardware device 130, 230, and more specifically, to the example second hardware device 230 (FIG. 2). More specifically, the second hardware device 230 will (for the purposes of the present discussions) be assumed to be a solid-state drive (SSD) memory unit 232. Of course, regarding practice of the present embodiments, the second hardware device 130, 230 is in no way limited to being an SSD memory unit 230, or to being a memory unit at all, e.g., practice of the embodiments apply equally as well to other types of hardware devices. Further, although the FIG. 2 second hardware device 230 may show a limited number or types of components by way of example, it can be appreciated that a greater or a fewer number or differing types of components may be employed for a given implementation.

The SSD memory unit 230 communicates data with the PCB or package 220 via the datalink 240. The datalink 240 will (for the purposes of the present discussions) be assumed to be a PCIe bus. Of course, regarding practice of the present embodiments, the datalink 240 is in no way limited to being a PCIe bus, or to being a PCI bus at all, e.g., practice of the embodiments apply equally as well to other types of datalinks.

With respect to the SSD memory unit 230, self-encrypting drives are commonly used to protect confidentiality of data at rest. That is, two common approaches to address data at rest confidentiality are self-encrypting drives or CPU-based encryption technologies (e.g., FileVault and Bitlocker). In a self-encrypting drive arrangement, the SSD memory unit 230 may be considered as being included within its own trust boundary, meaning that sufficient protective countermeasure arrangements have been made with respect to all items within the trust boundary such that a sufficient probability exists that it is unlikely that a nefarious party could tap any portion of the arrangement and successfully access intelligible data. Thus, within FIG. 2, the FIG. 2 drawn rectangle labeled 230 may be taken as a representation of not only the SSD memory unit 230, but also may be taken as a representation of the trust boundary of the SSD memory unit 230.

In the FIG. 2 example platform, a threat model might not consider attacking the link 226 between the SoC 222 and the DRAM 226 as an attack vector in scope, e.g., both are contained within the trust boundary 220 and are a difficult or impossible target. However, systems and platforms having platform exposed buses (such as the FIG. 2 PCIe bus 240) may be considered a viable threat (e.g., in remotely accessible multi-user systems) potentially subject to an attack 242. For improved or more comprehensive security, the exposed bus needs to be protected while maintaining, for example, the same security properties to the data to be protected when at rest. To bridge this gap and protect confidentiality of data while transiting on the exposed bus, the present embodiments propose to apply encryption to the PCIe 240 link between the SoC 222 and the SSD 232. There are many ways to apply encryption to the link, as the discussions ahead concerning various example embodiments will show.

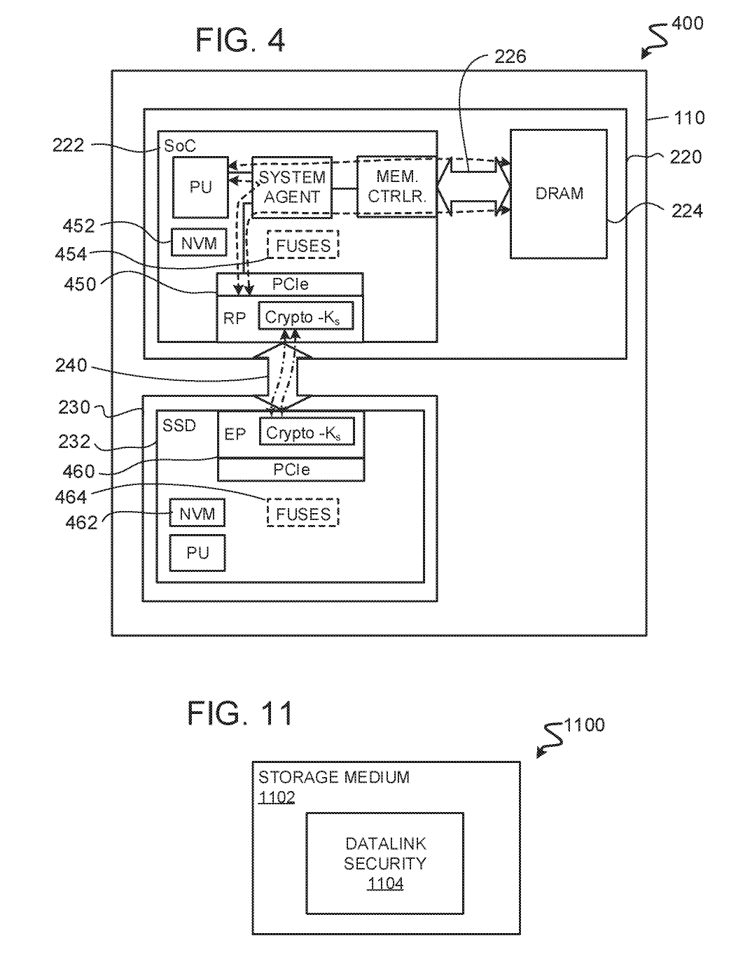

FIG. 4 illustrates an example of a system 400 having cryptography applied across a datalink. The SoC 222 may include the PCIe 240's root port (RP) (also called hereafter the PCIe controller 450), and the SSD may include the PCIe 240's end point (EP) (also called hereafter the PCIe controller 460). The proposed concept of link encryption may, for example, be conducted in both the PCIe RP and EP for encrypting data going outbound and decrypting data arriving inbound (See FIG. 4). That is, in order to facilitate the link encryption, the RP and EP may share a secret session key (Kₛ or Crypto-Kₛ).

As illustrated in FIG. 4, plain-text may be able to be communicated (illustrated by dashed-line paths) between various components within the trusted boundary 220, while cipher-text may be communicated (illustrated by dashed-dotted-line paths) between the first and second hardware devices 220, 230, via the datalink 240. Further illustrated, is a non-volatile memory (NVM) 452 and/or fuses 454 provided (for example) within the SoC 222, and a NVM 462 and/or fuses 464 provided (for example) within the SSD 232.

Regarding enabling an ability to perform link encryption, the SoC device 222 may include a security (or datalink encryption) controller 310 (FIG. 3). In various implementations, the security controller 310 may, for example, be incorporated and/or embedded into the SoC device 222 to provide security for the off-chip, off-board and/or off-package datalinks (e.g., datalinks) used in communication of data being input to and output from the SoC 222 and/or the PCB or package 220. The security controller 310 may be implemented by hardware and/or software in the SoC device 222. The security controller 310 may include, for example, a logic device such as a CPU and/or executable logic. In various embodiments, the security controller 310 may include datalink security logic for protecting on-chip data within the SoC device 222. Although the FIG. 4 combination 220 may show a limited number or types of components by way of example, it can be appreciated that a greater or a fewer number or differing types of components may be employed for a given implementation.

Although not shown in the figures, in one embodiment, the second hardware device 130, 230 may likewise include a similar security controller 310. However, for sake of brevity, only the security controller 310 of the SoC device 222 will be discussed. It should be understood however, that the security controller 310 discussions apply equally as well to any second hardware device security controller.

In various embodiments, the security controller 310 may be arranged to establish datalink security logic which may include, for example, decryption and encryption logic applied at the input and output of a datalink using one or more datalink security keys 312 (FIG. 3).

In various embodiments, the security controller 310 may be arranged to generate and manage the datalink security keys 312 for providing secure communication of data via datalinks to one or more off-chip, off-board and/or off-package unit, such as the second hardware device 130, 230. In one example embodiment, three datalink security keys 312 may be procured and managed, e.g., a nonce security key used to encrypt and/or decrypt a nonce exchange between the hardware devices; an outbound security key used to encrypt data leaving outbound from the hardware device across the datalink; and, an inbound security key used to decrypt data arriving inbound to the hardware device across the datalink. Although an example number or types of keys have been mentioned by way of example, it can be appreciated that a greater or a fewer number or differing types of keys may be employed for a given implementation.

Each datalink security key 312 may be implemented as a cryptographic key such as a public key, a private key, a symmetric or asymmetric key including, for example, a random bit-sequence (e.g., 32-bits, 64-bits, 128-bits or 256-bits) for encrypting and/or decrypting data. In various implementations, the security controller 310 may be arranged to generate the datalink security keys 312 by employing a random number generator (RNG) to ensure sufficient entropy. The security controller 310 may be arranged to generate datalink security keys 312 using various encryption techniques such as RSA, ECC, DES, 3DES, AES, AACS, and so forth. The embodiments are not limited in any of these contexts.

In some embodiments, for example, the datalink security keys 312 may include programmable key settings to support refreshing or establishing new datalink security keys at each reboot or session, for example, as discussed ahead. The embodiments are not limited in this context.

In some cases, common datalink security keys may be used in data communication between: the SoC 222 and the second hardware device 232 (see FIG. 2) via the data path 240; the SoC 222 and a third hardware device (not shown) via another respective data path (not shown); etc. In one embodiment, a common datalink security key may be used for SoC 222 data communications with each of the: second hardware device 230, third hardware device (not shown), fourth hardware device (not shown), etc. In another embodiment, a differing security key may be used respectively by the SoC 222 for data communications with each of the: second hardware (SoC) unit 232, third hardware device (not shown), fourth hardware device (not shown), etc. In other embodiments where input and output data are handled by differing respective ports, different respective datalink security keys may be used at the input port and output port of a secure datalink. In some cases, the datalink security keys 312 may include multiple input/output keys for a secure datalink, e.g., with differing keys being used for differing types of communications, for example.

In various embodiments, each of the second hardware device 130, third hardware device (not shown), fourth hardware device (not shown), etc., may include multiple addressable regions such as a port address, CPU address, main memory address, memory space address, register address, and so forth. In such embodiments, one or more datalink security key 312 may be associated with each of the multiple addresses. The security controller 310 may be arranged to associate or map datalink security keys 312 to particular addresses or address regions of the second hardware device 130, third hardware device (not shown), fourth hardware device (not shown), etc.

In various embodiments, only the security controller 310, for example, may be programmed with or include the capability to generate the datalink security keys 312 and write datalink security keys to a non-volatile memory (NVM), within the SoC 222. For example, the SoC device 222 may employ a particular protocol so that only the security controller 310, for example, may generate the datalink security keys 312.

In various implementations, the security controller 310 may generate and write the datalink security keys 312 and datalink security logic in response to an initialization command (e.g., boot code) or a new session of the host CPU 302-2. For example, during secure boot or after reset of the SoC device 222, the security controller 310 may initialize and enable the datalink security keys. In some embodiments, the datalink security keys may be generated during a secure boot using an on-chip public key as a root of trust.

In various embodiments, the security controller 310 may implement a bypass mode to turn off the datalink security. For example, the security controller 310 may program a bypass value (e.g. all 0's or all 1's) to instruct the datalink security logic (e.g., XOR or XNOR function) to perform a bypass. Such bypass mode may be useful in situations where it is unnecessary or redundant to implement security by the security controller 310. For example, when already encrypted/protected program (e.g., commercial movie) data is being communicated between the first hardware device 220 and the second hardware device 230, it may be unnecessary (e.g., redundant) to further encrypt/protect the program data.

It should be appreciated that embodiments may be used to protect various types of compressed or uncompressed content or information. In various embodiments, for example, the content or information may be associated with one or more images, image files, image groups, pictures, digital photographs, music file, sound files, voice information, videos, video clips, video files, video sequences, video feeds, video streams, movies, broadcast programming, television signals, web pages, user interfaces, graphics, textual information (e.g., encryption keys, serial numbers, e-mail messages, text messages, instant messages, contact lists, telephone numbers, task lists, calendar entries, hyperlinks), numerical information, alphanumeric information, character symbols, and so forth. The content or information also may include command information, control information, routing information, processing information, system file information, system library information, software (e.g., OS software, file system software, application software, game software), firmware, an application programming interface (API), a program, an applet, a subroutine, an instruction set, an instruction, computing code, logic, words, values, symbols, and so forth.

Description turns next to various relevant definitions or concepts, and then to various specific example embodiments which detail example types of keys used, and examples of how such keys may be obtained.

A “session key(s)” may be defined as a crypto key(s) utilized during actual data-transfer communication sessions conducted by the hardware devices. That is, data sent outbound onto the datalink is encrypted using a session key, and data received inbound across the datalink is decrypted using a session key. If communications are conducted between the hardware devices using the session key(s) and as long as the session key(s) is not known by others (e.g., any nefarious party), such communications would only be intelligible to the exchanging hardware devices. The session key may be symmetrical or asymmetrical. Further, the session keys may be permanent (e.g., never changed), semi-permanent (e.g., changed infrequently) or may be non-permanent (e.g., frequently changed, such as upon initiation of each communication session or boot).

A “pairing key(s)” may be defined as a crypto key(s) utilized to pair or associate two hardware devices together with each other, such that secure communications may be enabled between the two hardware devices. The pairing key(s) may, for example, be symmetrical, asymmetrical, secret (e.g., private) and/or public. Cryptography may be applied to communications conducted between the hardware devices using the pairing key(s). If communications are conducted between the hardware devices using the pairing key(s) and as long as the pairing key is not known by others (e.g., any nefarious party), such communications would only be intelligible to the exchanging hardware devices. As one non-limiting, non-exhaustive use, the pairing key(s) may be utilized to conduct cryptographic communications between the hardware devices so as to secretly agree upon a session key(s) to be used for actual data-transfer communication sessions conducted between the hardware devices.

Hardware devices may determine that session key(s) (or any other type of keys) are in “agreement” with each other, when some type of comparison confirms that session key(s) held by the respective hardware devices are consistent (e.g., identical) with each other. As non-limiting examples, comparison may be made between: the first and second hardware device's session keys; first and second nonces resultant from a same nonce having been processed (e.g., encrypted; encrypted, then decrypted) using the first and second hardware devices' session keys, respectively; first and second signatures resultant from a same signature having been processed (e.g., encrypted; encrypted, then decrypted) using the first and second hardware devices' session keys, respectively; etc. Once agreement of a session key(s) has been confirmed, the session keys will have been considered validated and safe to use to perform encryption and/or decryption of communications between the hardware devices.

As to an entity performing the comparison, one of the hardware devices may receive an item for comparison (e.g., session key; nonce; signature) from the other hardware device, and perform comparison with its own item. Such would be a single authentication of the session key, meaning that there is a single (uni-directional) confirmation of agreement. As another example, each of the hardware devices may independently receive an item for comparison (e.g., session key; nonce; signature) from the other hardware device, and perform comparison with its own item. Such would be a double (bi-directional) authentication of the session key, meaning that there are two (double) separate confirmations of agreement. As another example, some third hardware device may receive an item for comparison (e.g., session key; nonce; signature) from each of the hardware devices, and perform comparison of the received items, and report agreement or disagreement result back to the first and second hardware devices.

Use of agreement represents one example, non-limiting key-establishment procedure. Another key-establishment procedure may be a predetermined exchange of parameters (information) between hardware devices, or some other determination of parameters, and then the parameters used to establish a key. For example, a resultant key may be determined via a function which utilizes the parameters, e.g., as a function of information contributed by both hardware devices. Parameters (information) which may be exchanged between hardware devices may be numbers, colors, names, etc. Non-limiting examples of parameters which may be determined may be: a characteristic of the datalink communicatively coupling the hardware devices, for example: a round-trip transit time of a signal sent and received via the datalink; a phase fluctuation in a fiber datalink; etc. Implementation of embodiments are not limited in this context.

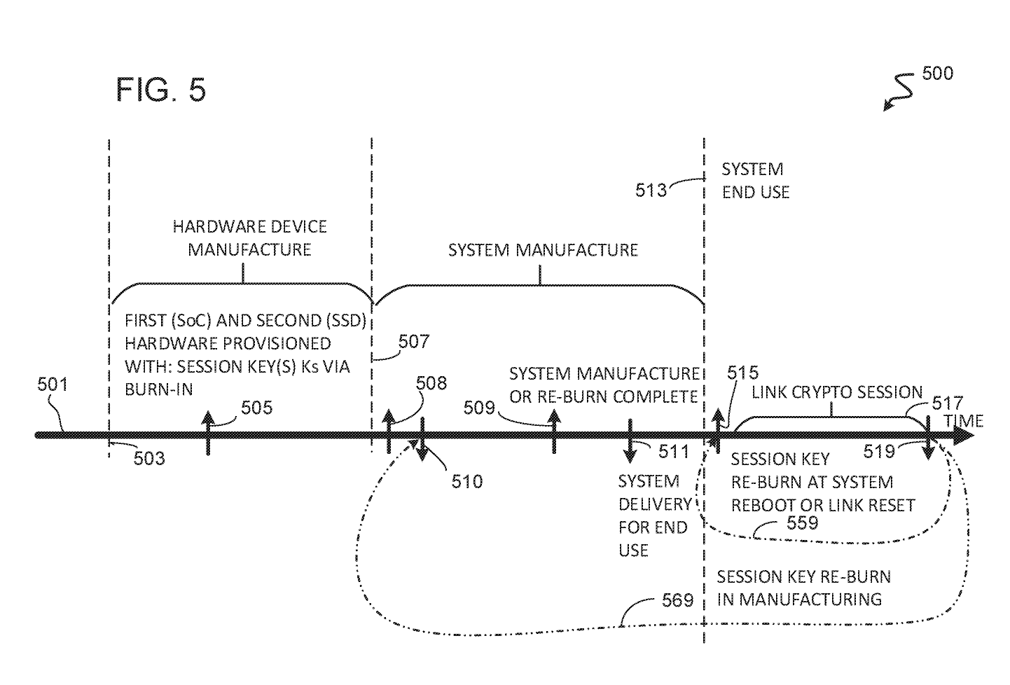

FIG. 5 illustrates an example timeline 500 of an example embodiment. That is, FIG. 5 illustrates an example “session-key-only” embodiment which involves use of only session keys Kₛ. More particularly, with such session-key-only embodiment, pairing keys are not utilized, and public key encryption (cryptography) is not used. Instead, a symmetrical session key Kₛ may be burned (e.g., via burnable fuses) into each of the first and second hardware devices.

Referring to time axis 501, session key burn-in may, for example, be effected at an example time 505 located within at a hardware device manufacturing time range shown between times 503 and 507. Alternatively, key burn-in may be effected at an example time 508 located within a system manufacturing time range shown between times 507 and 513 for provisioning the hardware devices into a system. Session keys may, for example, be provided by a corporate administrator and/or IT personnel.

With the system manufacture complete 509 and the session key(s) provisioned, the system may be delivered 511 for end use 513. Then, using the session key(s), the first and second hardware devices can conduct a crypto session 517 within an end-use time. For example, beginning any time after at a time 513, and ending, for example, at a time 519.

While the session-key-only embodiment is simplistic in that only session keys Kₛ are used, such embodiment may have limitations. More particularly, if the provisioned session keys Kₛ are utilized for an entire life span of the hardware devices or system, a crypto security level realized over time may be less than ideal in that a nefarious party has unlimited time (e.g., the entire life span) to crack or hack the session key(s) Kₛ.

As one improvement, the session key(s) Kₛ may (in another “resettable-session-key-only” embodiment) be changed over time. For example, the FIG. 5 procedures may be again utilized, but the session key(s) may be changed: periodically; every boot or link reset; when key compromise is detected; etc. As one example of session key(s) change, FIG. 5 further shows via a representative loop 559, that a session key(s) re-burn 515 may be conducted in the field. As another example, FIG. 5 further shows via a representative loop 569, that the first and second hardware devices may be returned to a manufacturing or repair facility in which a session key(s) re-burn 510 may be conducted.

However, in practice, the hardware devices may have a limited number of fuses to be burnt, and accordingly, there may be a limited number of times in which the session keys may be reset. Further, unless the hardware device includes an arrangement to self-burn-in new session keys while in the field, the hardware device may have to be temporarily taken out of end-use and returned to the manufacturer or repair facility for the burn-in of a new session key.

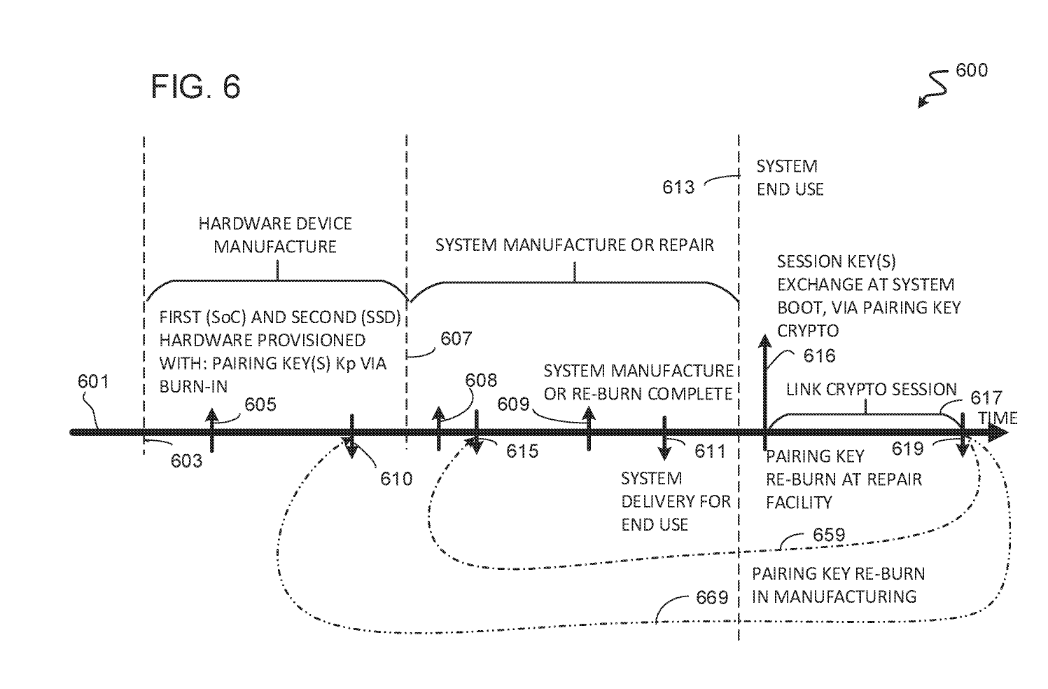

FIG. 6 illustrates an example timeline 601 of another example embodiment. More particularly, FIG. 6 illustrates an example “burnt-pairing-key” embodiment having example procedures 600 which involve use of burnt-in pairing keys. That is, no pairing key exchange or public key cryptography is conducted between first and second hardware devices to exchange or agree upon a pairing key(s) Kₚ. Instead, a symmetrical pairing key Kₚ is burned (e.g., via burnable fuses) into each of the first and second hardware devices. Referring to timeline 601, pairing key burn-in may, for example, be effected at an example time 605 located within a manufacturing time range shown between times 603 and 607. Alternatively, key burn-in may be effected at an example time 608 located within a system manufacturing time range shown between times 607 and 613, for provisioning the hardware devices into a system. The pairing key(s) Kₚ may, for example, be assigned by an original device manufacturer (ODM). With the system manufacture complete 609 and the session key(s) provisioned, the system may be delivered 611 for end use 613.

As was mentioned previously, the pairing key may be utilized to conduct an initial pairing key cryptographic communications 616 between the hardware devices so as to secretly agree upon a session key(s) to be used for actual data-transfer communication sessions conducted between the hardware devices. Thereafter, the first and second hardware devices can conduct a session key crypto session 617 within an end-use time. For example, beginning after 616 and ending, for example, at a time 619.

The above burnt-pairing-key embodiment may have limitations. More particularly, burning-in of the pairing key, in essence, effects a “hard pairing” in that the burned-in keys are more permanent in comparison to a “soft pairing” where keys are stored electronically and more easily changed. In one embodiment, if one hardware device were to fail, both hardware devices of the pair may disadvantageously be considered equally discardable due to a level of difficulty in changing the burnt-in pairing keys.

As one improvement, the pairing keys Kₚ may (in another “resettable-burnt-pairing-key” embodiment) be changeable. For example, the FIG. 6 procedures may be again utilized, but upon failure of one unit, the other (non-failed) hardware device of the pair may be recycled/re-paired by negating the prior burnt-in paring key(s) Kₚ and burning-in new pairing key(s) Kₚ. As one example of pairing key(s) change, FIG. 6 further shows via a representative loop 659p, that a pairing key(s) re-burn 615 may be conducted at a system repair facility. As another example, FIG. 6 further shows via a representative loop 669, that the first and second hardware devices may be returned to a hardware manufacturing facility in which a session key(s) re-burn 610 may be conducted.

As a disadvantage, the hardware devices may have a limited number of fuses to be burnt, and accordingly, there may be a limited number of times in which the pairing keys may be reset. Further, unless the hardware device includes an arrangement to self-burn-in new pairing keys while deployed in the field, the hardware device may have to be taken out of end-use and returned to the manufacturer or repair facility for the burn-in of a new pairing key(s).

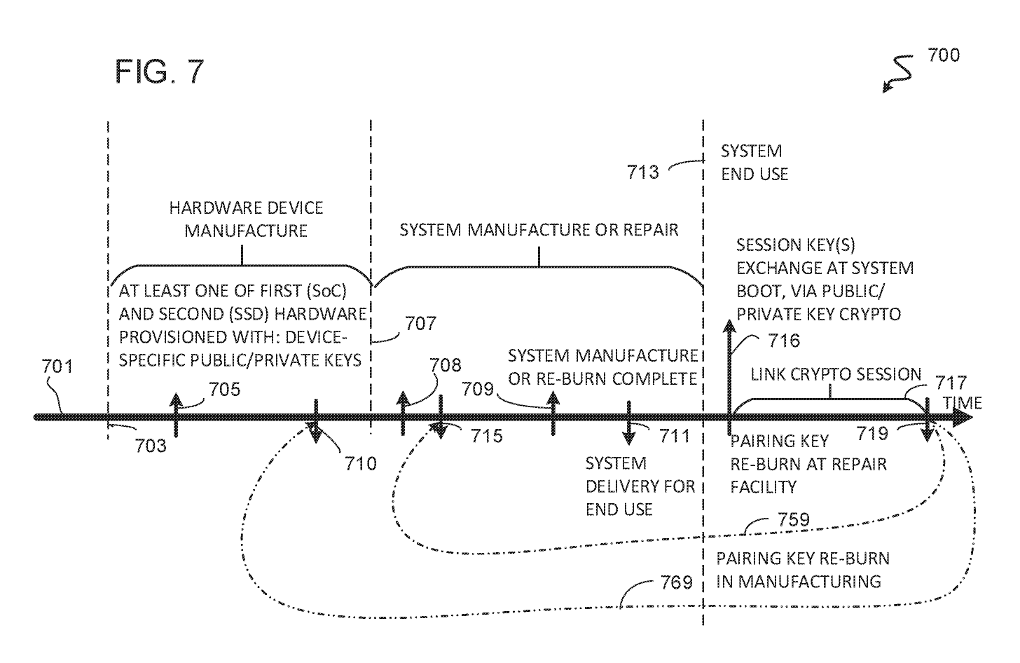

FIG. 7 illustrates an example timeline 701 of an example “session-key-via-single-public-authentication-at-boot” embodiment. More particularly, a single (e.g., one-directional) authentication process may be conducted at boot, for example, via a public key cryptography to establish a session key(s). That is, a pairing key(s) is not used, and instead, only a session key(s) is established. The session key Kₛ may be symmetrical. Public key cryptography may be used in a process to establish the session key(s).

At least one of the hardware devices may pre-include a device (unit, part, etc.)-specific set of public/private keys which may be utilized to conduct the single-public-authentication cryptography process. As shown by the example procedures 700, such device (unit, part, etc.)-specific set of public/private keys may have been provisioned to the hardware device by the ODM at an example time 705 located within at a hardware device manufacturing time range shown between times 703 and 707. Alternatively, the public/private keys may be provisioned at an example time 708 located within a system manufacturing time range shown between times 707 and 713 for provisioning the hardware devices into a system, or may even provisioned (not shown) within an end-use time. Public/private keys may, for example, be provided by an ODM, a corporate administrator and/or IT personnel. With the system manufacture complete 709 and the public/private keys provisioned, the system may be delivered 711 for end use 713.

Next, the public/private keys may be utilized to conduct an initial key cryptographic communications 716 between the hardware devices so as to secretly agree upon a session key(s) to be used for actual data-transfer communication sessions conducted between the hardware devices. Thereafter, the first and second hardware devices can conduct a session key crypto session 717 within an end-use time. For example, beginning after at 716, and ending, for example, at a time 719.

While the single-public-authentication-at-boot embodiment is simplistic in that only public key cryptography and session keys Kₛ are used, such embodiment may have limitations. More particularly, a boot-time delay associated with a public key cryptography process may be unacceptably long for an end-use/end-user, as is further discussed ahead.

As an enhancement of the above “single-public-authentication” embodiment, a “session-key-via-double-public-authentication-at-boot” embodiment may be implemented. That is, the above-discussed FIG. 7 “single-public-authentication” discussions may apply equally as well to an arrangement which utilizes a “double-public-authentication” process between the first and second hardware devices. With this “double-public-authentication” process, both hardware devices may pre-include a device (unit, part, etc.)-specific set of public/private keys (via 705, 708) which may then both be utilized (at 716) to conduct the double-public-authentication cryptography process.

With double-public-authentication, the authentication process may be implemented in both directions (bi-directional), e.g., from the first-to-second hardware devices direction, and from the second-to-first hardware devices direction. Enhanced security may be provided by such double-authentication, in that authentication is confirmed by each of the hardware devices in differing directions (e.g., bi-directionally).

Any of the previously-discussed loop approaches for changing the session or pairing key(s), may similarly be applied for changing the device-specific public/private keys. Non-limiting examples are shown by FIG. 7's loops 759 and 769, and representative arrows 715 and 710, respectively.

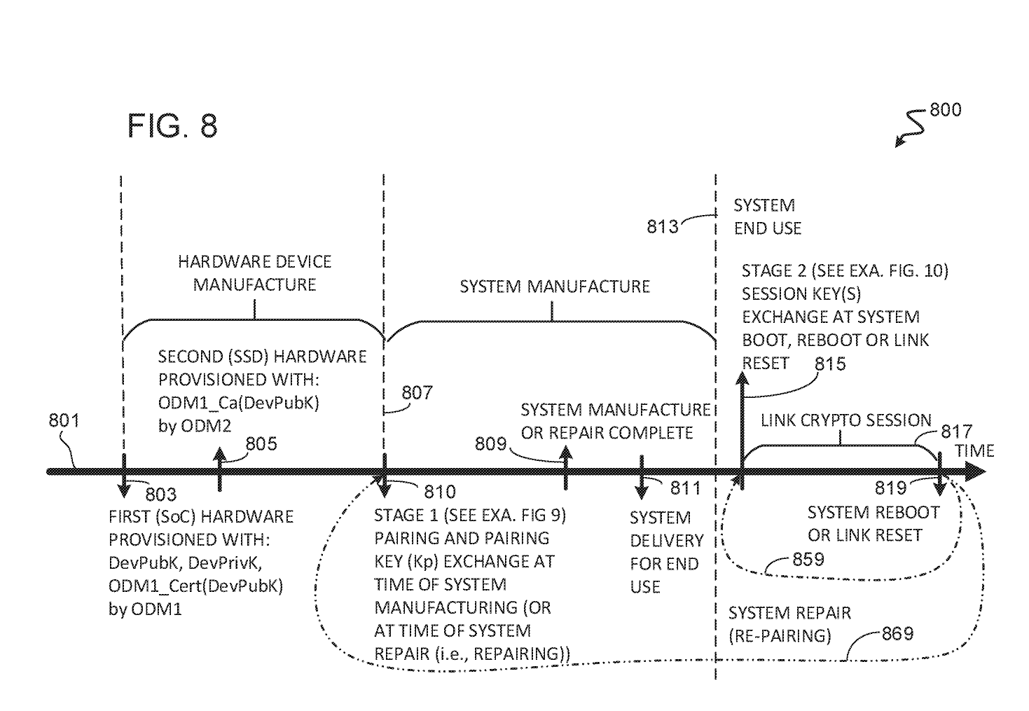

FIG. 8 illustrates another example embodiment in which a two-stage approach which may be implemented for a “single-authentication-pairing-key-exchange” embodiment, for example. Such two-stage FIG. 8 embodiment will first be described in general terms, and later in greater detail.

Before any stages, a left side of FIG. 8 shows that at least one of the hardware devices may pre-include a device (unit, part, etc.)-specific set of public/private keys which may be subsequently utilized in stage #1, to conduct the single-authentication cryptography process. Such device (unit, part, etc.)-specific set of public/private keys may have been provisioned to the hardware device by the ODM at a time of manufacture thereof (as one non-limiting example).

Next, a central portion of FIG. 8 shows that at a stage #1, for example, a pairing key exchange may be performed at a time of system manufacturing or repair. That is, at an original device manufacturer (ODM) facility or repair center facility, a symmetric pairing key (referred to hereafter as Kₚ) may be exchanged, for example, using the device-specific keys and public key cryptography between the first (SoC) hardware device 120, 220 and the second (SSD) hardware device 130, 230. Once the pairing key Kₚ is generated and/or agreed upon, a copy of such Kₚ pairing key may be stored in a NVM in each of the hardware devices.

Next, a right-side portion of FIG. 8 shows that a stage #2 session key exchange may be performed in the field, e.g., during an end-use implementation. That is, in the field, every time the link is reset and/or the system is rebooted for end-use, the first (SoC) hardware device 120, 220 and the second (SSD) hardware device 130, 230 may utilize the pairing key to conduct a cryptography process to exchange or agree upon a symmetric session key (referred to hereafter as Kₛ). With such new Kₛ provisioned with every link reset, Kₛ may be considered ephemeral as it is lost every time the link is reset.

The FIG. 8 two stage approach proposed herein offers distinct advantages, which may be detailed as follows. More particularly, the use of public crypto and assignment of public keys in the ODM facility or repair facility, avoids hard pairing of the hardware devices, e.g., any SSD can be paired with any SoC. In an event where the SoC or SSD needs refurbishing, a repair center can readily run the pairing protocol again as there has not been permanent fusing applied to the hardware device. Further, as an advantage, the proposed pairing scheme (e.g., Kp exchange) at ODM facility hides the time penalty which would be involved with running of the public crypto from the end-user, and enables the use of faster symmetric (private Ks) cryptography when the device is deployed in the field (e.g., during end-use). As a result, boot time impact to the end-user is minimized due to the described key exchange protocol.

In addition to the above maintaining key material integrity and confidentiality, the following security objectives may be obtained. More particularly, confidentiality is provided to data transiting on bus 240 exposed on the platform between the SoC and SSD package (e.g., on PCIe Link). Further, an ODM/Repair Center may be prevented from injecting their own key or from reading key material exchanged on the bus. That is, key integrity and key confidentiality are protected.

Still further, threats addressed by the proposed scheme may be as follows. More particularly a man in the middle attack may be prevented during key exchange where the adversary (e.g., ODM or Repair center) tries to inject its own key material or read key material. Further, a thief may be discouraged from stealing the highly secured system. Finally, a user in a multi-user system would be prevented from snooping the exposed link on the platform between SoC and SSD.

Discussion now turns to more detailed (but non-limiting) example FIG. 8 procedures 800 for affording the datalink encryption to the first (SoC) and second (SSD) hardware devices according to the example two-stage approach. The timeline is shown as time axis 801, and to begin, the time period ranging from time 803 up to the time 807 may (for the purposes of this disclosure) be said to represent a hardware device manufacturing time.

Assuming that ODM1 is the ODM of the SoC hardware device, then, at a time 803 of the SoC hardware unit manufacturing, the SoC hardware device may be provisioned by ODM1 with the following part-specific keys and certificate:
DevPubK, DevPrivK—Device specific Public/Private key pair; and
ODM1_Cert(DevPubK)—ODM Certificate for the device specific Public key.

Next, assuming that ODM2 is the ODM of the SSD hardware device, then, at a time 805 of device manufacturing, the SSD hardware device may be provisioned with ODM1_CA_PubK which is an ODM1 root certificate used to verify the ODM1 DevPubK. This certificate may be provided by the ODM1 to ODM2 (as the SSD manufacturer) in any secure fashion, such that ODM2 definitively knows that the ODM1_CA_PubK comes from the ODM1. Such may be done, for example, via a secured communications channel, disk exchange, etc. In the event that ODM1 (the SoC hardware manufacturer) and ODM2 (the SSD manufacturer) are the same manufacturer, then provisioning of ODM1_CA_PubK may be a simple in-house procedure.

Next, at a Stage #1 indicated representatively by arrow 810, a pairing and pairing key exchange may be conducted. More particularly, at system (e.g., server) manufacturing, an ODM1 SoC unit needs to be paired together with an ODM2 SSD unit. Pairing for purposes of the example embodiments discussed herein, is accomplished by physically pairing any SoC unit with any SSD unit (e.g., for installation into a system (such as a server unit) during system assembly or repair). Once paired, a pairing key Kₚ for the SoC/SSD pair may be established (e.g., generated using a random number generator; agreed upon; etc).

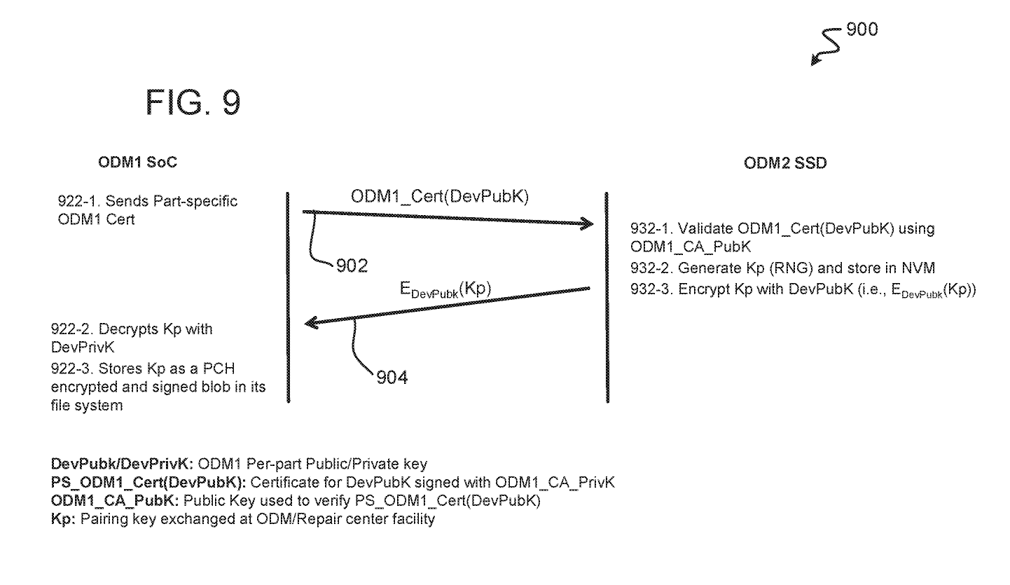

FIG. 9 illustrates an example (non-limiting) key exchange protocol 900 which may be conducted at FIG. 8's Stage #1. More particularly, the ODM1 SoC unit starts 922-1 the protocol by sending 902 the certificate for its part-specific public key (e.g., ODM1_Cert(DevPubK)) to the ODM2 SSD unit. Such sending may be conducted across the PCIe datalink 240 (FIG. 2) while the SoC 220 and SSD 230 units are already physically installed within the manufactured (e.g., server) system, or the sending may be conducted across a specialized manufacturing or repairing setup for pairing, before the SoC 220 and SSD 230 units are physically installed within the manufactured (e.g., server) system. That is, the FIG. 9 the key exchange protocol 900 may be conducted across any link, e.g., is not exclusive to being conducted across the PCIe datalink 240. As one example, other links existing within a system may be used for the exchange.

The SSD unit 232 then validates or verifies 932-1 the received certificate ODM1_Cert(DevPubK) using the ODM1_CA_PubK root certificate, and if verified, then 932-2 generates Kₚ using a random number generator (RNG) and stores Kₚ in a local NVM 462 (FIG. 4). The SSD unit then 932-3 encrypts Kₚ using the ODM1 SoC public key (DevPubK) that the SSD unit had initially verified, and sends 904 the resulting ciphertext E_{DevPubk}(Kₚ) back to the ODM1 SoC. The ODM1 SoC ends the protocol by 922-2 decrypting Kₚ using its private key (DevPrivK), and 922-3 stores Kₚ in the local NVM 452 (FIG. 4). If the NVM is instead an off-chip NVM, the ODM1 SoC may need to encrypt and sign Kₚ beforehand with a part-specific key. At this stage, the ODM1 SoC and the ODM2 SSD may be said to be paired with a non-volatile shared secret Kₚ stored within their respective NVMs. If such hardware devices are not already installed, they may now may be installed within the manufactured or repaired system (e.g., within a server chassis).

Storage of the pairing key(s) electronically (e.g., via NVM storage) may provide the advantages of “soft pairing” of the hardware devices, in which soft-pairing allows the electronic pairing key(s) to be subsequently overwritten with a new pairing key(s) for a re-pairing of one or both of the hardware devices with another/other hardware device/devices. Such overwriting of an old key(s) and rewriting of a new key(s) may be conducted electrically.

After storage of Kp has been conducted into the respective NVM, and the SoC and SSD have been installed within the manufactured or repaired system, the system manufacturing or repair is complete 809. Accordingly, a time period including the time 807 up to the time 811 or time 813 may be said as representing a system manufacturing time period. After completion of system manufacturing, the system is ready 811 for delivery to an end-user for subsequent end-use in the field, which begins at an end-use time 813.

Regarding latency considerations, operations to generate/store the pairing key Kₚ incurs a significant latency penalty. However, because the example embodiment's operations to generate/store the pairing key Kₚ were conducted at a pre-end-use time (e.g., at a time of system manufacturing, and before an end-use time), such latency-intensive operations are advantageously hidden from the end-use/end-user.

Next, a FIG. 9 Stage #2 session key exchange may be conducted at a time 815 within an end-use time (or “in-field use”).

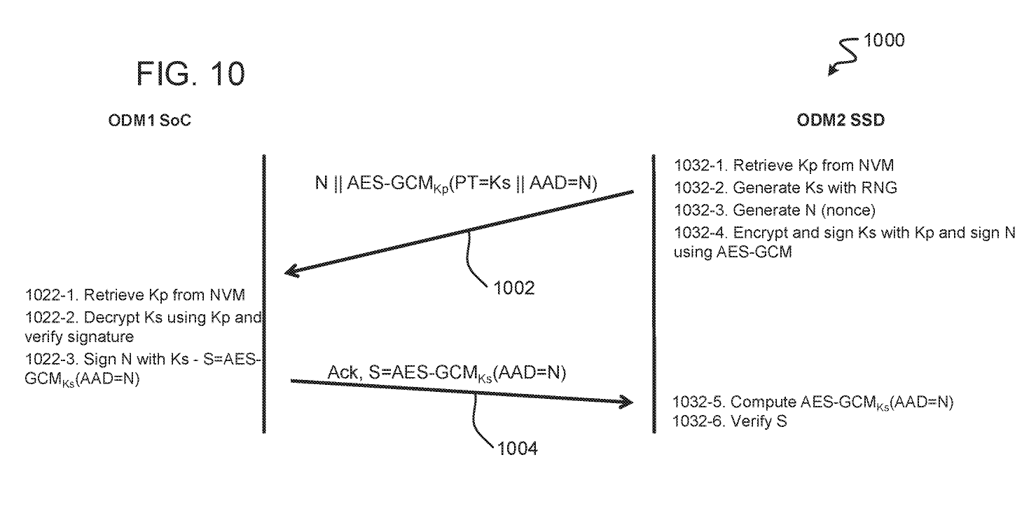

FIG. 10 illustrates a non-limiting example session key (Kₛ) exchange protocol 1000 which may be effected for FIG. 9's Stage #2. At every link reset, the ODM2 SSD unit may begin 1032-1 with a copy of the pairing key Kₚ (e.g., retrieved from its NVM 462), and generate a random number to produce 1032-2 one or more session key(s) Kₛ. The ODM2 SSD next 1032-3 generates a nonce N, and then 1032-4 encrypts and signs the session key(s) Kₛ using the pairing key Kₚ, and signs N using AES-GCM, for example. The SSD then sends 1002 information N∥AES-GCM_{Kp}(PT=Kₛ∥AAD=N) to the ODM1 SoC unit. The signature may be used at the end of the protocol to make sure the same session key(s) is shared by both parties.

The SoC receives such information and begins 1022-1 with a copy of the pairing key Kₚ (e.g., retrieved from its NVM 452), and uses 1022-2 the pairing key Kₚ to decrypt the session key(s) Kₛ and verify the signature. The last steps for the SoC consists in signing 1022-3 the nonce N with Kₛ-S=AES-GCM_{Ks}(AAD=N), and sending 1004 return information Ack, S=AES-GCM_{Ks}(AAD=N) to the SSD unit. The SSD unit receives the return information, and next 1032-5 computes AES-GCM_{Ks}(AAD=N), for example. Finally at operation 1032-6, the SSD unit verifies S.

In comparison to each other, operations to generate/store the pairing key Kₚ incurs a significantly greater latency penalty than a latency penalty of operations to generate/store the session key Kₛ. Again, because the more-latency-intensive operations to generate/store the pairing key Kₚ were conducted at a pre-end-use time (e.g., at a time of system manufacturing), such more-latency-intensive operations are advantageously hidden from the end-use/end-user resulting in a significant system latency improvement. That is, the end-use/end-user only has to experience the latency involved with the less-latency-intensive operations to generate and store the session key Kₛ.

In short, with example embodiments disclosed and discussed herein, the pairing key Kₚ may be called a “pre-end-use key” or “pre-end-use-provided pairing key”, while the session key Kₛ may be called an “end-use key”, “end-use-session-generated key” or simply “end-use session key”. Alternatively, the pairing key Kₚ may be called an “OE (original equipment)-provided-key” meaning that the pairing key Kₚ was provided by the OE manufacturer or by a repair facility or the IT department, and was not generated during in-field use (e.g., an end session) of the apparatus. In contrast, the session key Kₛ may be called a “field-generated key” meaning that the session key Kₛ was generated during in-field use (e.g., an end session) of the apparatus.

In implementation, evidence that a pairing key Kₚ within an apparatus is a “pre-end-use key” or “pre-end-use-provided pairing key” may be that the apparatus is shipped or delivered to an end-user (e.g., consumer) with a pairing key already stored in a NVM. In contrast, evidence that a session key Kₛ within an apparatus is an “end-use key”, “end-use-session-generated key” or simply “end-use session key” may be that the session key Kₛ is volatile and is erased or invalidated responsive to a power-down, reboot, restart, etc. Other types of evidence may be instrumental in determining when a key was generated or the type of key. For example, software coding within the apparatus may be relevant.

In returning to complete FIG. 8 discussions, assuming the (FIG. 10) final 1032-6 verification performed by the SSD is successful (e.g., “agreement” is achieved), the SoC unit and SSD unit have been proven to share the same session key Kₛ and can start a link encrypted session 817 of exchanging data in encrypted form using the common session key Kₛ.

The session 817 may continue using the same common session key Kₛ, for example, until such a time 819 as a link reset, system reboot and/or a system repair is needed. Regarding non-limiting examples of the time for a link reset or system reboot, such time 819 may be taken at: the countdown of a predetermined length of time (e.g., every two (2) hours); the occurrence of a predetermined date (e.g., every January 1^{st}) or predetermined time-of-day (e.g., at midnight); the occurrence of a predetermined number of datalink communications (e.g., 2000); the detection that the session key might have been compromised; etc. Once the time 819 for a link reset or system reboot is determined, the system may loop back 859 to re-perform the Stage 2 session key (Kₛ) exchange, so as to generate a new session key Kₛ′ for use in a new link encryption session.

Regarding non-limiting examples of the time for a system repair, such time 819 may be taken at: the failure or replacement of the SoC; the failure or replacement of the SSD; and/or the failure or replacement of any other component of the system. Once the time 819 for a system repair is determined, the system may loop back 869 to re-perform the Stage 1 pairing and pairing key (Kₚ) exchange, so as to generate a new pairing key Kp′ for use in subsequent session key Ks generation operations until the pairing key is again replaced.

As to key life-span, the pairing key(s) Kp may be thought of as a more permanent key(s) in comparison to the session key(s) Ks. That is, the pairing key(s) may (in one non-limiting example) be changed only when a pairing or re-pairing of the hardware devices occurs, whereas the session key(s) Ks may (in one non-limiting example) be changed more frequently such as upon a reboot or a new session.

One distinct advantage is that the present example embodiments' generation/storage/use of a soft pairing key Kₚ to soft pair the first (SoC) and second (SSD) hardware devices together (rather than use of a hard pairing key which is permanently inflicted (e.g., by fusing or burning)), allows any non-failed one of the first (SoC) and second (SSD) hardware devices to be subsequently reused and soft re-paired to any other hardware device. As one example, if an SSD-1 unit of an initially-paired SoC-1/SSD-1 pair experiences a failure, then the non-failed SoC-1 unit may be subsequently soft re-paired with a replacement SSD-2 unit as a SoC-1/SSD-2 pair. As another example, if a system (e.g., server) fails for other reasons, then a non-failed SoC-4 unit and non-failed SSD-4 unit of a non-failed SoC-4/SSD-4 pair, may each be recycled into available inventory, perhaps for subsequent soft re-pairings with other units at a later time, e.g., as a SoC-4/SSD-7 pair and as a SoC-5/SSD-4 pair.

Next, a “double-authentication-pairing-key-exchange” embodiment may be an enhancement of the above FIGS. 8-9 “single-authentication-pairing-key-exchange” embodiment. That is, the above FIGS. 8-9 “single-authentication” discussions may apply equally as well to an arrangement which utilizes a “double-authentication” process between the first and second hardware devices. With this “double-authentication” process, both hardware devices may pre-include a device (unit, part, etc.)-specific set of public/private keys which may then both be utilized to conduct a double-authentication cryptography process, where the single-authentication process may be implemented in both directions, e.g., from the first-to-second hardware devices direction, and from the second-to-first hardware devices direction. Enhanced security may be provided by double-authentication, in that authentication is confirmed by each of the hardware devices in differing directions.

Although the embodiments are described as supporting certain types of encryption techniques for purposes of illustration, it can be appreciated that the embodiments are not limited in this context and may support various other encryption techniques. Furthermore, in some implementations, the security controller 310 may be arranged to provide reconfigurable and/or upgradeable security measure. For example, the security controller 310 may provide support for ciphers and/or encryption techniques that are not supported by hardware implementation using software (e.g., programmable state machine) control of ciphers and/or encryption to support a variety of vendor security protocols and customer encrypted off-chip code.

As mentioned previously, the aforementioned system-on-a-chip (SoC) device and encrypted storage device are non-limiting, non-exhaustive examples of a hardware device, and a network interface controller (NIC) may be another example. That is, in one embodiment, a NIC device may be provided external to SoC device, and a datalink may couple the NIC device to the SoC device. Alternatively, a NIC device may be provided separately (discretely) from a storage device, and a datalink may couple the NIC device to the storage device. In each of these non-exhaustive examples, the above-described datalink security embodiments may be implemented to protect the datalink between the SoC and NIC devices, or the datalink between the NIC and storage devices.

Operations for various embodiments may have been described with reference to the figures and accompanying examples. Some of the figures may include a timing flow and/or logic flow. It can be appreciated that an illustrated timing flow and/or logic flow merely provides one example of how the described functionality may be implemented. Further, a given timing flow and/or logic flow does not necessarily have to be executed in the order presented unless otherwise indicated. In addition, a timing flow and/or logic flow may be implemented by a hardware element, a software element executed by a processor, or any combination thereof. The embodiments are not limited in this context.

Phraseology within this disclosure (including claims) reciting any phrase such as an item (e.g., an element) “at least a portion of which is implemented in hardware” (or something similar or analogous), should be interpreted as meaning that the item may be embodied as a hardware/software combination which operate together (i.e., the hardware effects the operations of the software. That is, software never operates alone and necessarily involves operation with hardware.

FIG. 11 illustrates one embodiment of an article of manufacture 1100. As shown, the article 1100 may include a storage medium 1102 to store datalink or datalink security logic 1104 for performing at least some of the various operations in accordance with the described embodiments. In various embodiments, the article 1100 may be implemented by various systems, components, and/or modules.

The article 1100 and/or machine-readable storage medium 1102 may include one or more types of computer-readable storage media capable of storing data, including volatile memory or, non-volatile memory, removable or non-removable memory, erasable or non-erasable memory, writeable or re-writeable memory, and so forth. Examples of a machine-readable storage medium may include, without limitation, RAM, DRAM, DRAM, SDRAM, static RAM (SRAM), ROM, programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information.

The article 1100 and/or machine-readable storage medium 1102 may store datalink security logic 1104 including instructions, data, and/or code that, if executed by a machine, may cause the machine to perform a method and/or operations in accordance with the described embodiments. Such a machine may include, for example, any suitable processing platform, computing platform, computing device, processing device, computing system, processing system, computer, processor, or the like, and may be implemented using any suitable combination of hardware and/or software.

The datalink security logic 1104 may include, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Discussion turns now to additional examples.

An example 1 concerning an apparatus to couple a system-on-chip (SoC) to encrypt data on a datalink, comprising: an SoC device to communicatively couple to a hardware device via a datalink, the SoC comprising: a key-establish element at least a portion of which is implemented in hardware, the key-establish element to establish at least one session key with the hardware device, via a key-establishment procedure; and an encryption/decryption element at least a portion of which is implemented in hardware, the encryption/decryption element to encrypt/decrypt data communicated with the hardware device via the datalink, using the at least one session key.

An example 2 concerning an apparatus of example 1, the key-establish element including an authentication element at least a portion of which is implemented in hardware, the authentication element to conduct authentication and public key encryption with the hardware device to establish the at least one session key, at every boot up of the SoC.

An example 3 concerning an apparatus of example 2, the authentication comprising: a single authentication in one direction between the SoC and the hardware device, or a bi-directional authentication in both directions between the SoC and the hardware device.

An example 4 concerning an apparatus of example 1, further comprising: a non-volatile storage element having at least one pairing key stored therein, the at least one pairing key comprising a pre-end-use-provided key to establish a paired relationship between the SoC and the hardware device; and the key-establish element to establish the at least one session key via cryptographic communications with the hardware device using the at least one pairing key, the at least one session key comprising an end-use-established key.

An example 5 concerning an apparatus of example 4, comprising: the key-establish element including an authentication element at least a portion of which is implemented in hardware, the authentication unit to: conduct authentication and public key encryption with the hardware device to establish the at least one pairing key; and conduct authentication and cryptography with the hardware device to establish the at least one session key, at every boot up or communication session reset of the SoC.

An example 6 concerning an apparatus of example 5, the authentication via the element, comprising: a single authentication in one direction between the SoC and the hardware device, or a bi-directional authentication in both directions between the SoC and the hardware device.

An example 7 concerning an apparatus of any one of example 1 to 3, the datalink being a Peripheral Component Interconnect (PCI) Express bus (PCIe).

An example 8 concerning an apparatus of any one of example 4 to 6, the datalink being a Peripheral Component Interconnect (PCI) Express bus (PCIe).

An example 9 concerning an apparatus of any one of example 4 to 6, the datalink being any one of a Peripheral Component Interconnect (PCI) bus, PCI Extended (PCI-X) bus, XSI bus, CardBus and IP-based Ethernet bus.

An example 10 concerning an apparatus to couple a hardware device to encrypt data on a datalink connected to a system-on-chip (SoC), comprising: a hardware device to communicatively couple to a system-on-chip (SoC) device via a datalink, the hardware device comprising: a key-establish element at least a portion of which is implemented in hardware, the key-establish element to establish at least one session key with the SoC device, via a key-establishment procedure; and an encryption/decryption element at least a portion of which is implemented in hardware, the encryption/decryption element to encrypt/decrypt data communicated with the SoC device via the datalink, using the at least one session key.

An example 11 concerning an apparatus of example 10, the key-establish element including an authentication element at least a portion of which is implemented in hardware, the authentication element to conduct authentication and public key encryption with the SoC device to establish the at least one session key, at every boot up of the hardware device.

An example 12 concerning an apparatus of example 11, the authentication comprising: a single authentication in one direction between the hardware apparatus and the SoC device, or a bi-directional authentication in both directions between the hardware apparatus and the SoC device.

An example 13 concerning an apparatus of example 10, further comprising: a non-volatile storage element having at least one pairing key non-volatilely stored therein, the at least one pairing key comprising a pre-end-use-provided key to establish a paired relationship between the hardware apparatus and the SoC device; and the key-establish element to establish the at least one session key via cryptographic communications with the SoC device using the at least one pairing key, where the at least one session key comprising an end-use-established key.

An example 14 concerning an apparatus of example 13, comprising: the key-establish element including an authentication element at least a portion of which is implemented in hardware, the authentication element to: conduct authentication and public key encryption with the SoC device to establish the at least one pairing key; and conduct authentication and cryptography with the SoC device to establish the at least one session key, at every boot up or communication session reset of the hardware device.

An example 15 concerning an apparatus of example 14, the authentication via the authentication element, comprising: a single authentication in one direction between the hardware device and the SoC device, or a bi-directional authentication in both directions between the hardware apparatus and the SoC device.

An example 16 concerning an apparatus of any one of example 10 to 12, the datalink being a Peripheral Component Interconnect (PCI) Express bus (PCIe).

An example 17 concerning an apparatus of any one of example 13 to 15, the datalink being a Peripheral Component Interconnect (PCI) Express bus (PCIe).

An example 18 concerning an apparatus of any one of example 13 to 15, the datalink being any one of a Peripheral Component Interconnect (PCI) bus, PCI Extended (PCI-X) bus, XSI bus, CardBus and IP-based Ethernet bus.

An example 19 concerning a method of providing datalink security across a datalink communicatively coupling a system-on-chip (SoC) device to a hardware device within a system, the method comprising: establishing at least one session key in the SoC device and the hardware device; and encrypting/decrypting data communicated via the datalink, at each of the SoC device and the hardware device, using the at least one session key.

An example 20 concerning a method of example 19, the establishing the at least one session key including conducting authentication and public key encryption between the SoC device and the hardware device to establish the at least one session key, at every boot up of the SoC.

An example 21 concerning a method of example 20, the authentication comprising: a single authentication in one direction between the SoC device and the hardware device, or a bi-directional authentication in both directions between the hardware apparatus and the SoC device.

An example 22 concerning a method of example 19, further comprising: storing at least one pairing key non-volatilely within non-volatile storage of each of the SoC device and the hardware device, the at least one pairing key comprising a pre-end-use-provided key and establishing a paired relationship between the SoC and the hardware device; and effecting the establishing the at least one session key via cryptographic communications between the SoC device and the hardware device using the at least one pairing key during an end-use of the system, the at least one session key comprising an end-use-established key.

An example 23 concerning a method of example 22, comprising: the establishing the at least one paring key, including conducting authentication and public key encryption between the SoC device and the hardware device to establish the at least one pairing key; and the establishing the at least one session key including conducting authentication and public key encryption between the SoC device and the hardware device to establish the at least one session key, at every boot up or communication session reset of the system.

An example 24 concerning a method of example 23, the authentication comprising: a single authentication in one direction between the SoC device and the hardware device, or a bi-directional authentication in both directions between the hardware apparatus and the SoC device.

An example 25 concerning a method of any one of example 22 to 24, the datalink being a Peripheral Component Interconnect (PCI) Express bus (PCIe).

An example 26 concerning a system to couple a system-on-chip (SoC) and a hardware device to encrypt data across a datalink, comprising: a system-on-chip (SoC) device to communicatively couple to a hardware device via a datalink, the SoC including: a first key-establish element at least a portion of which is implemented in hardware, the first key-establish element to establish at least one session key, via agreement with the hardware device; and a first encryption/decryption element at least a portion of which is implemented in hardware, the first encryption/decryption element to encrypt/decrypt data communicated with the hardware device via the datalink, using the at least one session key; the hardware device to communicatively couple to the system-on-chip (SoC) device via the datalink, the hardware device including: a second key-establish element at least a portion of which is implemented in hardware, the second key-establish element to establish the at least one session key, via agreement with the SoC device; and a second encryption/decryption element at least a portion of which is implemented in hardware, the second encryption/decryption element to encrypt/decrypt data communicated with the SoC device via the datalink, using the at least one session key.

An example 27 concerning a system of example 26, the first and second key-establish elements to establish the at least one session key including a first and second authentication element, respectively, at least a portion of which is implemented in hardware, the first and second authentication element to conduct authentication and public key encryption between the SoC device and the hardware device to establish the at least one session key, at every boot up of the system.

An example 28 concerning a system of example 27, the authentication by the first and second authentication elements comprising: a single authentication in one direction between the SoC device and the hardware device, or a bi-directional authentication in both directions between the hardware apparatus and the SoC device.

An example 29 concerning a system of example 26, further comprising the SoC device and the hardware device each including: a non-volatile storage element having at least one pairing key non-volatilely stored therein, the at least one pairing key comprising a pre-end-use-provided key to establish a paired relationship between the SoC and the hardware device; and the first and second key-establish elements to establish the at least one session key via cryptographic communications using the at least one pairing key, the at least one session key comprising an end-use-established key.

An example 30 concerning a system of example 29, comprising: the first and second key establish elements each including an authentication element at least a portion of which is implemented in hardware, the authentication element to: conduct authentication and public key encryption between the SoC device and the hardware device to establish the at least one pairing key; and conduct authentication and public key encryption between the SoC device and the hardware device to establish the at least one session key, at every boot up or communication session reset.

An example 31 concerning a system of example 30, the authentication via the first and second authentication elements, comprising: a single authentication in one direction between the SoC device and the hardware device, or a bi-directional authentication in both directions between the hardware apparatus and the SoC device.

An example 32 concerning an apparatus of any one of example 26 to 31, 33 to 36 and 46 to 47, the hardware device comprising a: computer-readable storage device; solid-state storage device (SSD); or network interface controller (NIC) hardware.

An example 33 concerning a system of any one of example 26 to 28, the datalink being a Peripheral Component Interconnect (PCI) Express bus (PCIe).

An example 34 concerning a system of any one of example 26 to 28, the datalink being any one of a Peripheral Component Interconnect (PCI) bus, PCI Extended (PCI-X) bus, XSI bus, CardBus and IP-based Ethernet bus.

An example 35 concerning a system of any one of example 29 to 31, the datalink being a Peripheral Component Interconnect (PCI) Express bus (PCIe).

An example 36 concerning a system of any one of example 29 to 31, the datalink being any one of a Peripheral Component Interconnect (PCI) bus, PCI Extended (PCI-X) bus, XSI bus, CardBus and IP-based Ethernet bus.

An example 37 concerning a method of any one of example 19 to 21, the datalink being a Peripheral Component Interconnect (PCI) Express bus (PCIe).

An example 38 concerning a method of any one of example 19 to 21, the datalink being any one of a Peripheral Component Interconnect (PCI) bus, PCI Extended (PCI-X) bus, XSI bus, CardBus and IP-based Ethernet bus.

An example 39 concerning a method of any one of example 22 to 24, the datalink being any one of a Peripheral Component Interconnect (PCI) bus, PCI Extended (PCI-X) bus, XSI bus, CardBus and IP-based Ethernet bus.

An example 40 concerning an apparatus of any one of example 1 to 3 and 7, the key-establishment procedure being a check for agreement between the SoC device and the hardware device.

An example 41 concerning an apparatus of any one of example 4 to 6 and 8 to 9, the key-establishment procedure being a check for agreement between the SoC device and the hardware device.

An example 42 concerning an apparatus of any one of example 10 to 12 and 16, the key-establishment procedure being a check for agreement between the SoC device and the hardware device.

An example 43 concerning an apparatus of any one of example 13 to 15 and 17 to 18, the key-establishment procedure being a check for agreement between the SoC device and the hardware device.

An example 44 concerning an apparatus of any one of example 19 to 21 and 37 to 38, the key-establishment procedure being a check for agreement between the SoC device and the hardware device.

An example 45 concerning an apparatus of any one of example 22 to 25 and 39, the key-establishment procedure being a check for agreement between the SoC device and the hardware device.

An example 46 concerning an apparatus of any one of example 26 to 28 and 33 to 34, the key-establishment procedure being a check for agreement between the SoC device and the hardware device.

An example 47 concerning an apparatus of any one of example 26 to 31 and 33 to 36, the key-establishment procedure being a check for agreement between the SoC device and the hardware device.

An example 48 concerning an apparatus for end-use by an end-user to couple a hardware device to encrypt data on a datalink, comprising: a first hardware unit; and a datalink interface to couple to a datalink coupled to a second hardware unit, to allow data communication between the first hardware unit and the second hardware unit; wherein the first hardware unit is configured to utilize a pre-end-use-provided pairing key Kp established for the first hardware unit and the second hardware unit, to communicate with the second hardware unit via the datalink, to generate an end-use session key Ks useable to conduct encrypted communication via the datalink for a communication session.

An example 49 concerning an apparatus of example 48, wherein the pairing key Kp is a public key, and the session key Ks is a symmetric session key.

An example 50 concerning an apparatus of any one of example 48 to 49, wherein the first hardware unit comprises a respective non-volatile-memory (NVM) storing the pairing key Kp as a cryptographic key.

An example 51 concerning an apparatus of any one of example 48 to 50, wherein the first and second hardware units are pre-end-use-soft-paired hardware units soft-paired together by storage of the pairing key Kp as a common cryptographic key, within respective non-volatile-memory (NVM) assigned to each of the first and second hardware units.

An example 52 concerning an apparatus of any one of example 48 to 51, wherein the first hardware unit comprises a datalink encryption controller to effect encryption and decryption of communications to and from the datalink, using the session key Ks.

An example 53 concerning an apparatus of any one of example 48 to 52, wherein components of the first hardware unit, have trust boundary characteristics associated therewith, where the trust boundary characteristics includes built-in resistance to non-authorized access thereof, and wherein at least a portion of the datalink does not have trust boundary characteristics.

An example 54 concerning a system to couple hardware units to encrypt data across a datalink, comprising: a first hardware unit; a second hardware unit; and a datalink coupling the first hardware unit and the second hardware unit, to allow data communication between the first hardware unit and the second hardware unit; wherein each of the first hardware unit and the second hardware unit non-volatilely store a pre-end-use-provided pairing key Kp, and each of the first hardware unit and the second hardware unit are configured to communicate with the other of the first hardware unit and the second hardware unit via the datalink using the pairing key Kp, to generate an end-use session key Ks useable to conduct encrypted communication via the datalink for a communication session.

An example 55 concerning an apparatus of example 54, wherein the pairing key Kp is a public key, and the session key Ks is a symmetric session key.

An example 56 concerning an apparatus of any one of example 54 to 55, wherein each of the first hardware unit and the second hardware unit comprises a respective non-volatile-memory (NVM) storing the pairing key Kp as a common cryptographic key.

An example 57 concerning an apparatus of any one of example 54 to 56, wherein the first and second hardware units are pre-end-use-soft-paired hardware units soft-paired together by storage of the pairing key Kp as a common cryptographic key, within respective non-volatile-memory (NVM) assigned to each of the first and second hardware units.

An example 58 concerning an apparatus of any one of example 54 to 57, wherein each of the first hardware unit and the second hardware unit comprises a datalink encryption controller to effect encryption and decryption of communications to and from the datalink, using the session key Ks.

An example 59 concerning an apparatus of any one of example 54 to 58, wherein components of the first hardware unit and the second hardware unit, each has trust boundary characteristics associated therewith, where the trust boundary characteristics includes built-in resistance to non-authorized access thereof, and wherein at least a portion of the datalink does not have trust boundary characteristics.

An example 60 concerning a computer-implemented method for effecting datalink security to a datalink of an apparatus for end-use by an end-user, with the apparatus including: a first hardware unit; a second hardware unit; and the datalink coupling the first hardware unit and the second hardware unit, to allow data communication between the first hardware unit and the second hardware unit; the method comprising: prior to an end-use session of the apparatus, establishing a pairing of the first hardware unit with the second hardware unit by generating a pairing key Kp for common use by the first hardware unit and the second hardware unit; and utilizing the pairing key Kp in communications between the first hardware unit and the second hardware unit via the datalink, to generate an end-use session key Ks useable to conduct encrypted communication via the datalink for a communication session.

An example 61 concerning a computer-implemented method of example 60, wherein the pairing key Kp is a public key, and the session key Ks is a symmetric session key.

An example 62 concerning a computer-implemented method of any one of example 60 to 61, wherein each of the first hardware unit and the second hardware unit includes a respective non-volatile-memory (NVM) for storing the pairing key Kp as a common cryptographic key, and wherein the establishing includes storing the pairing key Kp in the respective non-volatile-memory (NVM) of the first hardware unit and the second hardware unit.

An example 63 concerning a computer-implemented method of any one of example 60 to 62, wherein the pairing is more particularly a soft pairing of the first and second hardware units together by storage of the pairing key Kp as a common cryptographic key, within respective non-volatile-memory (NVM) assigned to each of the first and second hardware units.

An example 64 concerning a computer-implemented method of any one of example 60 to 63, the method further comprising: effecting encryption and decryption of communications to and from the datalink at each of the first hardware unit and the second hardware unit, via a datalink encryption controller provided in each of the first hardware unit and the second hardware unit, in which the datalink encryption controller uses the session key Ks.

An example 65 concerning a computer-implemented method of any one of example 60 to 64, wherein components of the first hardware unit and the second hardware unit, each has trust boundary characteristics associated therewith, where the trust boundary characteristics includes built-in resistance to non-authorized access thereof, and wherein at least a portion of the datalink does not have trust boundary characteristics.

An example 66 concerning at least one non-transitory machine readable medium comprising a plurality of instructions that, in response to being executed on an apparatus for end-use by an end-user, cause the apparatus to implement a method for effecting datalink security to a datalink of the apparatus, with the apparatus including: a first hardware unit; a second hardware unit; and the datalink coupling the first hardware unit and the second hardware unit, to allow data communication between the first hardware unit and the second hardware unit; the method including: prior to an end-use session of the apparatus, establishing a pairing of the first hardware unit with the second hardware unit by generating a pairing key Kp for common use by the first hardware unit and the second hardware unit; and utilizing the pairing key Kp in communications between the first hardware unit and the second hardware unit via the datalink, to generate an end-use session key Ks useable to conduct encrypted communication via the datalink for a communication session.

An example 67 concerning a medium of example 66, wherein the pairing key Kp is a public key, and the session key Ks is a symmetric session key.

An example 68 concerning a medium of any one of example 66 to 67, wherein each of the first hardware unit and the second hardware unit includes a respective non-volatile-memory (NVM) for storing the pairing key Kp as a common cryptographic key, and wherein the establishing includes storing the pairing key Kp in the respective non-volatile-memory (NVM) of the first hardware unit and the second hardware unit.

An example 69 concerning a medium of any one of example 66 to 68, wherein the pairing is more particularly a soft pairing of the first and second hardware units together by storage of the pairing key Kp as a common cryptographic key, within respective non-volatile-memory (NVM) assigned to each of the first and second hardware units.

An example 70 concerning a medium of any one of example 66 to 69, the method further comprising: effecting encryption and decryption of communications to and from the datalink at each of the first hardware unit and the second hardware unit, via a datalink encryption controller provided in each of the first hardware unit and the second hardware unit, in which the datalink encryption controller uses the session key Ks.

An example 71 concerning a medium of any one of example 66 to 70, wherein components of the first hardware unit and the second hardware unit, each has trust boundary characteristics associated therewith, where the trust boundary characteristics includes built-in resistance to non-authorized access thereof, and wherein at least a portion of the datalink does not have trust boundary characteristics.

An example 72 concerning a machine readable medium including code, when executed, to cause a machine to perform the method of any one of example 19 to 25, 37 to 39, 44 to 45 and 60 to 65.

An example 73 concerning an apparatus to couple a system-on-chip (SoC) to encrypt data on a datalink, comprising: an SoC device to communicatively couple to a hardware device via a datalink, the SoC comprising: a key-establish means for establishing at least one session key with the hardware device, via a key-establishment procedure; and an encryption/decryption means for encrypting/decrypting data communicated with the hardware device via the datalink, using the at least one session key.

An example 74 concerning an apparatus of example 73, the key-establish means including an authentication means for conducting authentication and public key encryption with the hardware device to establish the at least one session key, at every boot up of the SoC.

An example 75 concerning an apparatus of example 74, the authentication comprising: a single authentication in one direction between the SoC and the hardware device, or a bi-directional authentication in both directions between the SoC and the hardware device.

An example 76 concerning an apparatus of example 73, further comprising: a non-volatile storage element having at least one pairing key stored therein, the at least one pairing key comprising a pre-end-use-provided key to establish a paired relationship between the SoC and the hardware device; and the key-establish means for establishing the at least one session key via cryptographic communications with the hardware device using the at least one pairing key, the at least one session key comprising an end-use-established key.

An example 77 concerning an apparatus of example 76, comprising: the key-establish means including an authentication means for: conducting authentication and public key encryption with the hardware device to establish the at least one pairing key; and conducting authentication and cryptography with the hardware device to establish the at least one session key, at every boot up or communication session reset of the SoC.

An example 78 concerning an apparatus of example 77, the authentication via the element, comprising: a single authentication in one direction between the SoC and the hardware device, or a bi-directional authentication in both directions between the SoC and the hardware device.

An example 79 concerning an apparatus of example 74, the datalink being a Peripheral Component Interconnect (PCI) Express bus (PCIe).

An example 80 concerning an apparatus of example 76, the datalink being a Peripheral Component Interconnect (PCI) Express bus (PCIe).

An example 81 concerning an apparatus of example 76, the datalink being any one of a Peripheral Component Interconnect (PCI) bus, PCI Extended (PCI-X) bus, XSI bus, CardBus and IP-based Ethernet bus.

Unless specifically stated otherwise; it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures or characteristics may be combined from any of the described embodiments, in any suitable manner in one or more embodiments.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

What is claimed is:

1. An apparatus, comprising:
a system-on-chip (SoC) device to communicatively couple to a hardware device via a datalink, the SoC comprising:
a key-establish element at least a portion of which is implemented in hardware, the key-establish element to establish at least one session key with the hardware device, via a key-establishment procedure; and
an encryption/decryption element at least a portion of which is implemented in hardware, the encryption/decryption element to encrypt/decrypt data communicated with the hardware device via the datalink, using the at least one session key.

2. An apparatus as claimed in claim 1, the key-establish element including an authentication element at least a portion of which is implemented in hardware, the authentication element to conduct authentication and public key encryption with the hardware device to establish the at least one session key, at every boot up of the SoC.

3. An apparatus as claimed in claim 2, the authentication comprising: a single authentication in one direction between the SoC and the hardware device, or a bi-directional authentication in both directions between the SoC and the hardware device.

4. An apparatus as claimed in claim 1, further comprising:
a non-volatile storage element having at least one pairing key stored therein, the at least one pairing key comprising a pre-end-use-provided key to establish a paired relationship between the SoC and the hardware device; and
the key-establish element to establish the at least one session key via cryptographic communications with the hardware device using the at least one pairing key, the at least one session key comprising an end-use-established key.

5. An apparatus as claimed in claim 4, comprising:
the key-establish element including an authentication element at least a portion of which is implemented in hardware, the authentication unit to:
conduct authentication and public key encryption with the hardware device to establish the at least one pairing key; and
conduct authentication and cryptography with the hardware device to establish the at least one session key, at every boot up or communication session reset of the SoC.

6. An apparatus as claimed in claim 5, the authentication via the element, comprising: a single authentication in one direction between the SoC and the hardware device, or a bi-directional authentication in both directions between the SoC and the hardware device.

7. An apparatus as claimed in claim 2, the datalink being a Peripheral Component Interconnect (PCI) Express bus (PCIe).

8. An apparatus as claimed in claim 4, the datalink being a Peripheral Component Interconnect (PCI) Express bus (PCIe).

9. An apparatus as claimed in claim 4, the datalink being any one of a Peripheral Component Interconnect (PCI) bus, PCI Extended (PCI-X) bus, XSI bus, CardBus and IP-based Ethernet bus.

10. An apparatus, comprising:
a hardware device to communicatively couple to a system-on-chip (SoC) device via a datalink, the hardware device comprising:
a key-establish element at least a portion of which is implemented in hardware, the key-establish element to establish at least one session key with the SoC device, via a key-establishment procedure; and
an encryption/decryption element at least a portion of which is implemented in hardware, the encryption/decryption element to encrypt/decrypt data communicated with the SoC device via the datalink, using the at least one session key.

11. An apparatus as claimed in claim 10, the key-establish element including an authentication element at least a portion of which is implemented in hardware, the authentication element to conduct authentication and public key encryption with the SoC device to establish the at least one session key, at every boot up of the hardware device.

12. An apparatus as claimed in claim 11, the authentication comprising: a single authentication in one direction between the hardware apparatus and the SoC device, or a bi-directional authentication in both directions between the hardware apparatus and the SoC device.

13. An apparatus as claimed in claim 10, further comprising:
a non-volatile storage element having at least one pairing key non-volatilely stored therein, the at least one pairing key comprising a pre-end-use-provided key to establish a paired relationship between the hardware apparatus and the SoC device; and
the key-establish element to establish the at least one session key via cryptographic communications with the SoC device using the at least one pairing key, where the at least one session key comprising an end-use-established key.

14. An apparatus as claimed in claim 13, comprising:
the key-establish element including an authentication element at least a portion of which is implemented in hardware, the authentication element to:
conduct authentication and public key encryption with the SoC device to establish the at least one pairing key; and
conduct authentication and cryptography with the SoC device to establish the at least one session key, at every boot up or communication session reset of the hardware device.

15. An apparatus as claimed in claim 14, the authentication via the authentication element, comprising: a single authentication in one direction between the hardware device and the SoC device, or a bi-directional authentication in both directions between the hardware apparatus and the SoC device.

16. An apparatus as claimed in claim 11, the datalink being a Peripheral Component Interconnect (PCI) Express bus (PCIe).

17. An apparatus as claimed in claim 13, the datalink being a Peripheral Component Interconnect (PCI) Express bus (PCIe).

18. An apparatus as claimed in claim 13, the datalink being any one of a Peripheral Component Interconnect (PCI) bus, PCI Extended (PCI-X) bus, XSI bus, CardBus and IP-based Ethernet bus.

19. A method of providing datalink security across a datalink communicatively coupling a system-on-chip (SoC) device to a hardware device within a system, the method comprising:
establishing at least one session key in the SoC device and the hardware device; and
encrypting/decrypting data communicated via the datalink, at each of the SoC device and the hardware device, using the at least one session key.

20. A method as claimed in claim 19, the establishing the at least one session key including conducting authentication and public key encryption between the SoC device and the hardware device to establish the at least one session key, at every boot up of the SoC.

21. The method as claimed in claim 20, the authentication comprising: a single authentication in one direction between the SoC device and the hardware device, or a bi-directional authentication in both directions between the hardware apparatus and the SoC device.

22. The method as claimed in claim 19, further comprising:
storing at least one pairing key non-volatilely within non-volatile storage of each of the SoC device and the hardware device, the at least one pairing key comprising a pre-end-use-provided key and establishing a paired relationship between the SoC and the hardware device; and
effecting the establishing the at least one session key via cryptographic communications between the SoC device and the hardware device using the at least one pairing key during an end-use of the system, the at least one session key comprising an end-use-established key.

23. The method as claimed in claim 22, comprising:
the establishing the at least one paring key, including conducting authentication and public key encryption between the SoC device and the hardware device to establish the at least one pairing key; and
the establishing the at least one session key including conducting authentication and public key encryption between the SoC device and the hardware device to establish the at least one session key, at every boot up or communication session reset of the system.

24. The method as claimed in claim 23, the authentication comprising: a single authentication in one direction between the SoC device and the hardware device, or a bi-directional authentication in both directions between the hardware apparatus and the SoC device.

25. The method as claimed in claim 22, the datalink being a Peripheral Component Interconnect (PCI) Express bus (PCIe).
